(19) United States
(12) Patent Application Publication
(10) Pub. No.: US 2004/0226520 A1
(43) Pub. Date: Nov. 18, 2004

(54) Arrangement for tethering horses

(76) Inventor: Jay A. Ballard, Mapleton, UT (US)

Correspondence Address: QUARLES & BRADY STREICH LANG, LLP, ONE SOUTH CHURCH AVENUE, SUITE 1700, TUCSON, AZ, 85701-1621, US

(21) Appl. No.: 10/435,830

(22) Filed: May 12, 2003

(51) Int. Cl. A01K 27/00

(52) U.S. Cl. 119/799

(57) ABSTRACT

An arrangement for tethering a horse includes a shaft which is resilient throughout. One end of the shaft is provided with a handle-like member for attachment to a tether while the other end of the shaft is provided with a cap. A body of deformable material surrounds the shaft in the area where the shaft enters the cap. The cap is connected to a carrier, and the carrier is pivotable on a support which is designed to be attached to a supporting surface such as the side of a horse trailer. A bolt urges the cap and the carrier against each other. The shaft is pivotable with the carrier between an operative position and a storage position, and the shaft can be locked in either of these positions. A horse can be tethered to the shaft in its operative position using a bungee cord.

### FIELD OF THE INVENTION

The invention relates to an arrangement for confining animals.

### DESCRIPTION OF THE PRIOR ART

One form of arrangement for confining animals includes a device known as a tie-out. Such a tie-out functions to keep an animal, typically a horse, at a certain maximum spacing from a trailer or other structure to which the horse is tethered. A tie-out generally includes a horizontal shaft which is mounted on the side of the trailer or other structure, and the horse is attached to the tie-out by way of a tie or tether.

U.S. Pat. No. 6,142,103 discloses a tie-out which is mounted on the side of a trailer or other structure at a height such that the tie-out is located above the head of a horse which is attached to the tie-out. The tie-out is stabilized by means of cables and is designed to pivot on a vertical axis.

Another tie-out is taught in U.S. Pat. No. 6,408,793. Rather than being pivotable on a vertical axis, this tie-out is designed to be rotated side-to-side, as well as up-and-down, in response to the pull of a horse which is attached to the tie-out. To this end, a spring is interposed between the horizontal shaft of the tie-out and a structure on which the tie-out is mounted.

### SUMMARY OF THE INVENTION

One aspect of the invention resides in an arrangement for confining an animal. The arrangement comprises a shaft for connection to the animal to restrict movement of the animal, and means for mounting the shaft on a surface.

In one embodiment of the confining arrangement, the mounting means includes a first mounting element for attachment to a surface and a second mounting element designed to support the shaft and to be supported by the first mounting element. This embodiment of the confining arrangement further comprises means for securing the second mounting element to the first mounting element, and the securing means includes a tightening element for establishing a connection between the first mounting element and the second mounting element. The tightening element is designed to urge the first mounting element and the second mounting element against each other.

A further embodiment of the confining arrangement additionally comprises means for inhibiting loss of the connection between the first mounting element and the second mounting element, and the inhibiting means includes a holding element for holding the tightening element

In another embodiment of the confining arrangement, the shaft for connection to an animal is resilient.

In an additional embodiment of the confining arrangement, the shaft has a first end for connection to an animal and a second end designed to be held by the mounting means. The mounting means here includes a housing for the second end of the shaft and the housing has an opening. The shaft projects from the housing through the opening, and a flexible body is located between the housing and the second end of the shaft.

In a further embodiment of the confining arrangement, the mounting means is designed to support the shaft for movement between a first position and a second position. As in the first embodiment outlined above, the mounting means includes a first mounting element for attachment to a surface and a second mounting element designed to support the shaft and to be movably supported by the first mounting element. In the present embodiment of the confining arrangement, the first mounting element is designed to support the second mounting element for movement thereby allowing the shaft to shift between the first and second positions, and such embodiment additionally comprises means for locking the shaft in both the first position and the second position. The locking means comprises a locking element designed to bridge the first mounting element and the second mounting element.

In yet another embodiment of the confining arrangement, the mounting means includes a mounting element having a first mounting member for attachment to a surface and a second mounting member designed to be supported by the first mounting member and to support the shaft for movement. The second mounting member is supportable by the first mounting member in at least two different orientations to permit movement of the shaft in different directions.

Still a further embodiment of the confining arrangement comprises, in addition to the shaft and the mounting means, a stretchable lead for connection to the shaft and to an animal to be confined.

Another aspect of the invention resides in a method of making an arrangement for the confinement of an animal.

One embodiment of the method comprises the steps of attaching a shaft designed to restrict movement of an animal to a mounting element designed to support the shaft, and securing this mounting element to another mounting element designed to be attached to a surface. The securing step includes urging the mounting elements against each other.

An additional embodiment of the method again comprises the steps of attaching a shaft designed to restrict movement of an animal to a mounting element designed to support the shaft, and securing this mounting element to another mounting element designed to be attached to a surface. The securing step involves establishing a connection between the mounting elements using a tightening element, and this embodiment of the method further comprises the step of inhibiting loss of the connection. The inhibiting step includes holding the tightening element with a holding element.

Another embodiment of the method comprises the steps of providing a housing having an opening, providing a shaft designed to restrict movement of an animal, and assembling the housing and the shaft so that one portion of the shaft is located in the housing and another portion of the shaft is located externally of the housing. The assembling step includes interposing a flexible body between a the housing and the internal portion of the shaft.

An additional aspect of the invention resides in a method of operating an arrangement which comprises a shaft for the confinement of an animal.

One embodiment of the operating method comprises the steps of attaching an animal to the shaft and flexing the shaft.

Another embodiment of the operating method relates to an arrangement in which a first mounting element is attached to a surface and a second mounting element supports the shaft and is movably supported by the first mounting element. Such embodiment of the operating method comprises the steps of moving the second mounting element and the shaft to a first position and locking the second mounting element and the shaft in the first position by bridging the first mounting element and the second mounting element with a locking element. This embodiment of the operating method further comprises the steps of removing the locking element, moving the second mounting element and the shaft to a second position and locking the second mounting element and the shaft in the second position by bridging the first mounting element and the second mounting element with the locking element.

An additional embodiment of the operating method concerns an arrangement which includes a mounting element having a first mounting member attached to a surface and a second mounting member supported by the first mounting member and movably supporting the shaft. Such embodiment of the operating method comprises the step of changing the orientation of the second mounting member on the first mounting member.

A further embodiment of the operating method relates to an arrangement in which the shaft is connected to a lead. This embodiment of the operating method comprises the steps of attaching an animal to the lead and stretching the lead.

Additional features of the invention will be forthcoming from the following detailed description of preferred embodiments when read in conjunction with the accompanying drawings.

### BRIEF DESCRIPTION OF THE DRAWINGS

FIG. 1 illustrates a shaft and other components of one embodiment of an animal tethering arrangement according to the invention.

FIG. 2 is a fragmentary sectional view, as seen in the direction of the arrows II-II of FIG. 1, showing the shaft as well as a cap on the shaft and also including side views of a fastening element for the shaft and mounting elements for the shaft.

FIG. 3 is a front view of a support which constitutes part of the arrangement of FIG. 1 and can be used to mount the shaft on a surface.

FIG. 4 is a rear view of the support of FIG. 3.

FIG. 5 is a side view of the support of FIG. 3.

FIG. 6 is an end view of the support of FIG. 3.

FIG. 7 is a front view of a locking element for use with the support of FIG. 3.

FIG. 8 is a side view of the locking element of FIG. 7.

FIG. 9 is a front view of a carrier which forms part of the arrangement of FIG. 1 and can be used to hold the shaft on the support of FIG. 3.

FIG. 10 is a rear view of the carrier of FIG. 9.

FIG. 11 is a side view of the carrier of FIG. 9 and also includes side view of fastening elements for connecting the carrier to the support of FIG. 3.

FIG. 12 is a view towards one end of the carrier of FIG. 9.

FIG. 13 is a view towards the opposite end of the carrier.

FIG. 14 is a plan view of one of the fastening elements of FIG. 1.

FIG. 15 is a side view of an arresting element for the locking element of FIGS. 7 and 8.

FIG. 16 is a front perspective view of a shaft and a mounting system of another embodiment of an animal tethering arrangement according to the invention with the shaft being rotatable in a horizontal plane and being locked in one of a plurality of positions by a locking pin.

FIG. 17 is similar to FIG. 16 but shows the shaft in another position.

FIG. 18 is similar to FIG. 17 but illustrates the shaft as being rotatable in a vertical plane.

FIG. 19 is a side view of the mounting system of FIG. 16.

FIG. 20 is a fragmentary sectional view in the direction of the arrows XX-XX of FIG. 16 with the locking pin omitted.

FIG. 21 is a front perspective view of a support which constitutes part of the mounting system of FIG. 16 and includes two carrying members shown in one of a plurality of orientations relative to a holding member.

FIG. 22 is a rear perspective view of the support of FIG. 21.

FIG. 23 is similar to FIG. 21 but shows the carrying members in another orientation relative to the holding member.

FIG. 24 is a fragmentary sectional view in the direction of the arrows XXIV-XXIV of FIG. 16.

### DESCRIPTION OF THE PREFERRED EMBODIMENTS

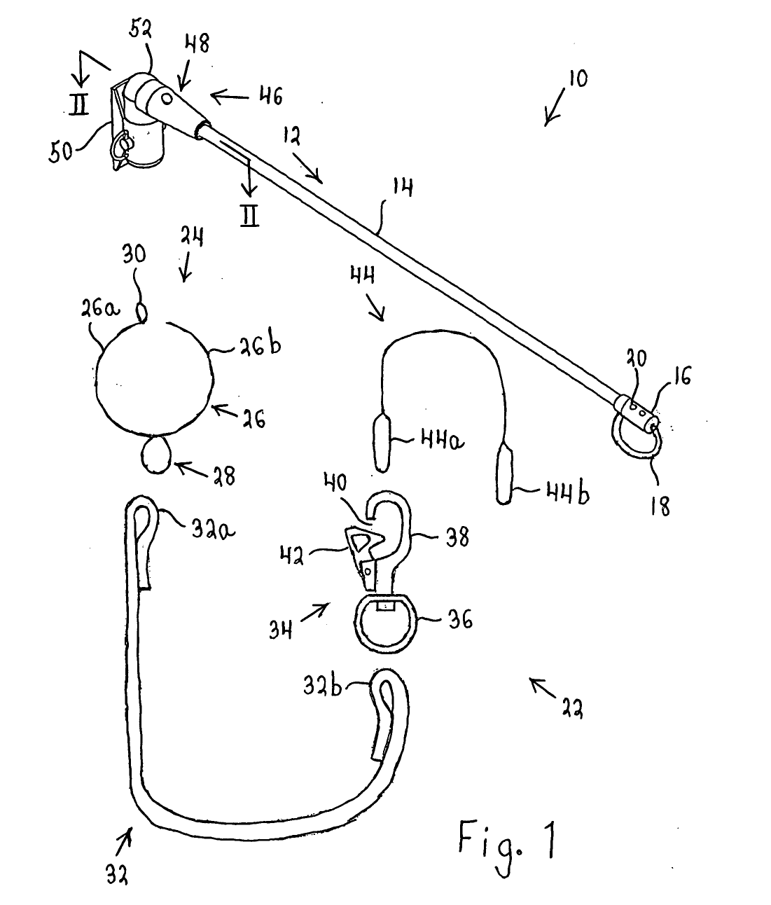

Referring to FIG. 1, the numeral 10 identifies an arrangement in accordance with the invention for tethering or confining an animal, particularly a horse.

The tethering arrangement 10 comprises a tie-out or spacing member 12 which includes a shaft 14, a cap or housing 16 mounted on one end of the shaft 14 and a C-shaped element 18 secured to the cap 16. The cap 16 is held on the shaft 14 by two fastening elements 20 which can, for example, be constituted by set screws. The C-shaped element 18 and the cap 16 cooperate to define a closed loop.

The shaft 14 here has a solid, circular cross section. However, the term “shaft” as used herein is not limited to such a configuration, and the shaft 14 could be tubular and could also have other than a circular cross section. Regardless of the configuration of the shaft 14, the latter is resilient or elastic throughout the entire length thereof. Hence, the shaft 14, which is essentially straight when unstressed, can bend to a noticeable degree under a bending stress and return to its original condition upon removal of such stress. The shaft 14 is advantageously composed of fiberglass.

The tethering arrangement 10 further comprises a system 22 for attaching the tie-out 12 to an animal. The attaching system 22 includes a connecting element 24 having a first strap or strap-like portion 26 and a second strap or strap-like portion 28. The strap 26 comprises two sections 26a and 26b which are of one piece but have respective ends which are discrete from each other. These ends can be separated to allow one or the other of the sections 26a,26b to be passed through the loop defined by the cap 16 and the C-shaped element 18 of the tie-out 12. One of the sections 26a,26b is provided with non-illustrated male coupling means while the other of the sections 26a,26b is provided with non-illustrated female coupling means, and the male and female coupling means can be mated once a section 26a,26b has been passed through the loop of the tie-out 12. This joins the sections 26a,26b to one another and anchors the connecting element 24 to the tie-out 12. The male and female coupling means can, for instance, be constituted by Velcro (trademark).

One of the discrete ends of the strap sections 26a,26b is formed with a tab 30 which is here in the form of a loop. The tab 30 can be used to disengage the male and female coupling means when it is desired to disconnect the connecting element 24 from the tie-out 12.

The strap 28 is secured to the strap 26 at the junction of the strap sections 26a,26b and defines a loop.

The system 22 for attaching the tie-out 12 to an animal additionally includes a tether or lead 32 which is preferably stretchable and is advantageously in the form of a bungee cord. One end of the tether 32 is formed with a loop 32a while the other end of the tether 32 is formed with a loop 32b. In the assembled condition of the attaching system 22, the loop 32a and the loop defined by the strap 28 of the connecting element 24 pass through one another so that a connection is established between the connecting element 24 and the tether 32.

The system 22 for attaching the tie-out 12 to an animal also includes an anchoring element 34. The anchoring element 34 comprises an anchoring ring 36 and a hook 38 which are joined to one another such that the ring 36 and the hook 38 can rotate relative to each other. In the assembled condition of the attaching system 22, the ring 36 and the loop 32b of the tether 32 pass through one another so that a connection is established between the tether 32 and the anchoring element 34.

The hook 38 has an opening 40, and a tongue 42 is mounted on the hook 38 for pivotal movement between a closed position in which the opening 40 is blocked and an open position in which the opening 40 is unblocked. The tongue 42 may be urged towards the closed position by a non-illustrated spring.

The system 22 for attaching the tie-out 12 to an animal can further include a flexible extension 44 which is here in the form of a strap or strap-like element having a loop 44a at one end thereof and a loop 44b at the other end thereof. The loop 44a can be slipped onto the hook 38 in the open position of the tongue 42 which is thereupon allowed to assume the closed position so that the loop 44a is unable to disengage itself from the hook 38. The loop 44b, on the other hand, is attached to a halter or the like mounted on an animal to be confined.

The extension 44 will normally be used for an animal which is hesitant to stress the tether 32 and the tie-out 12. For an animal which does not exhibit such hesitancy, it is possible to dispense with the extension 44.

The tethering arrangement 10 additionally comprises a system 46 for mounting the tie-out 12 on a surface, e.g., the side of a horse trailer or the side of a building. The mounting system 46 includes a cap or housing 48 on the end of the shaft 14 opposite that with the cap 16, a support or mounting element 50 designed to be affixed to a surface and a carrier or mounting element 52 attachable to the cap 48 and mountable on the support 50.

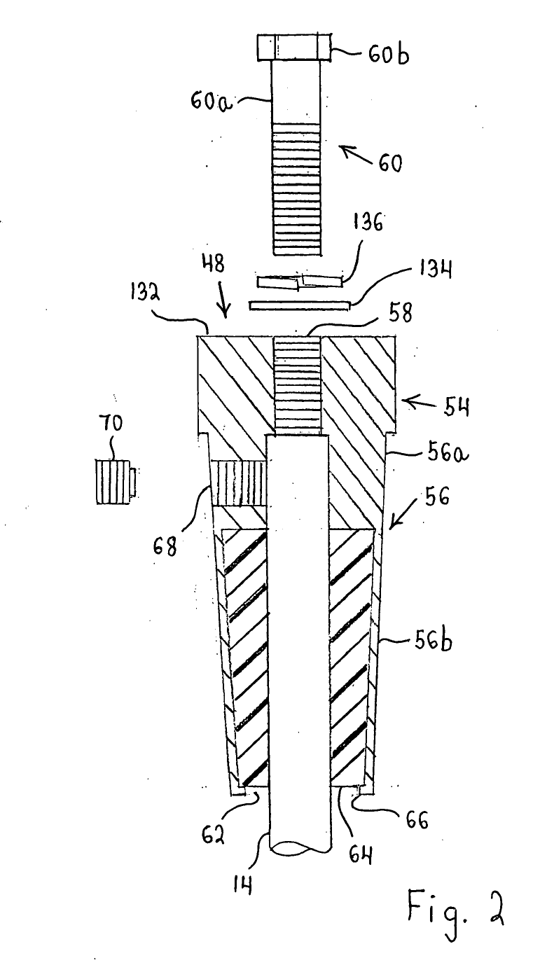

Considering FIG. 2, the cap 48 of the mounting system 46 comprises a cylindrical section 54 of circular cross section and a frustoconical section 56 which is coaxial with the cylindrical section 54. The cylindrical section 54 is provided with a threaded passage 58 which extends axially of the cylindrical section 54 and is designed to receive a threaded bolt or fastening element 60. The bolt 60 has a shaft 60a and a head or abutment 60b at one end of the shaft 60a, and the shaft 60a is threaded from the other end thereof partway to the head 60b.

The frustoconical section 56 of the cap 48 has a portion 56a which adjoins the cylindrical section 54 and a portion 56b which extends from the portion 56a in a direction away from the cylindrical section 54. The frustoconical portion 56b is provided with an opening 62 at the end thereof remote from the frustoconical portion 56a, and the shaft 14 of the tie-out 12 passes through the opening 62 into the frustoconical section 56. The frustoconical portion 56a has a passage which extends axially of the frustoconical portion 56a and is coaxial with the threaded passage 58 in the cylindrical section 54, and the passage in the frustoconical portion 56a snugly receives the end of the shaft 14 remote from the cap 16.

The frustoconical portion 56b is formed with a frustoconical chamber which accommodates a frustoconical, flexible or deformable body 64. The flexible body 64 extends from the opening 62 in the frustoconical portion 56b, or from the region of the opening 62, to the frustoconical portion 56a and defines a passage for the shaft 14. Such passage extends axially of the frustoconical portion 56b and is coaxial with the passage in the frustoconical portion 56a and with the threaded passage 58 in the cylindrical section 54. The flexible body 64 can, for example, be composed of plastic and advantageously consists of polyurethane. When the shaft 14 is subjected to a bending stress, the flexible body 64 prevents the shaft 14 from contacting any sharp edges which may be present adjacent to the opening 62. Thus, while the shaft 14 is under a bending stress, contact between the shaft 14 and a sharp edge adjoining the opening 62 could cause the shaft 14 to fracture.

The opening 62 in the frustoconical portion 56b is surrounded by an annular lip 66 which extends radially inward from the internal surface of the frustoconical portion 56b. The annular lip 66, which helps to hold the flexible body 64 in the frustoconical portion 56b, can be beveled in order to minimize sharp edges around the opening 62. It is possible to eliminate the lip 66 and to then bevel the end of the frustoconical portion 56b adjacent to the opening 62.

The flexible body 64 can be produced by molding a suitable material into the form of a sleeve, and the shaft 14 can then be inserted in the sleeve. Alternatively, the flexible body 64 can be produced by pouring a suitable material into the frustoconical portion 56b after the shaft 14 has been positioned therein. In either case, the flexible body 64 is interposed between the frustoconical portion 56b and a portion of the shaft 14 located in the frustoconical portion 56b.

The frustoconical portion 56a is provided with a threaded radial passage 68 which extends from the outer periphery of the frustoconical portion 56a to the axial passage in the frustoconial portion 56a. The radial passage 68 is designed to receive a set screw or fastening element 70 which helps to hold the shaft 14 in the frustoconical portion 56a.

As indicated previously, the system 46 for mounting the tie-out 12 on a surface includes, in addition to the cap 48 on the shaft 14, a support 50 designed to be affixed to a surface.

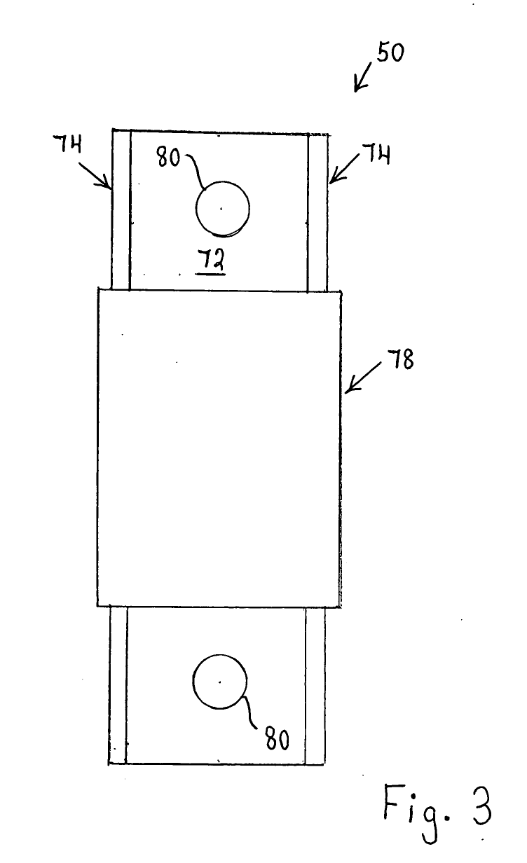

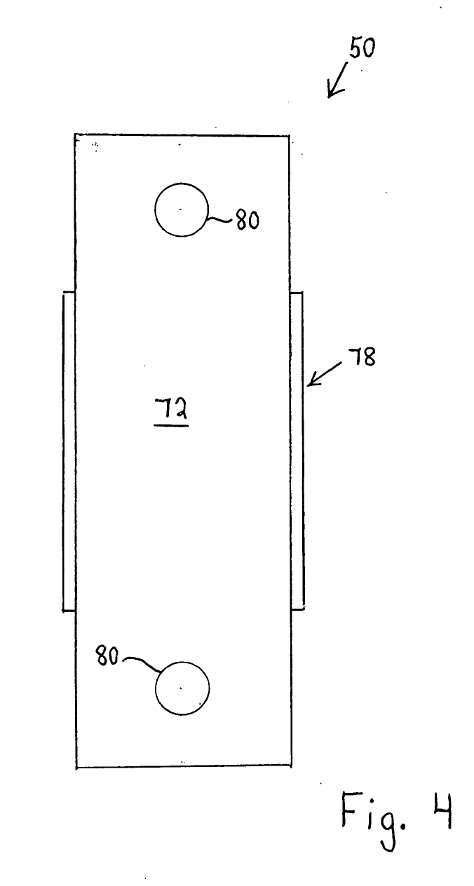

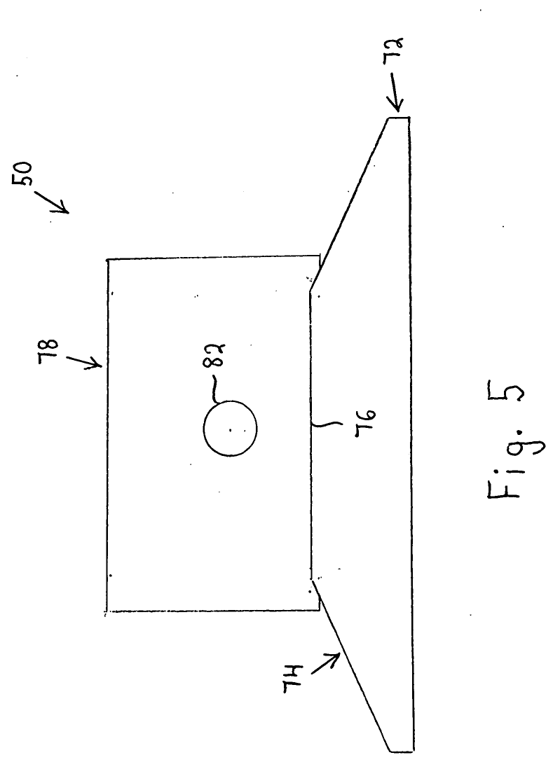

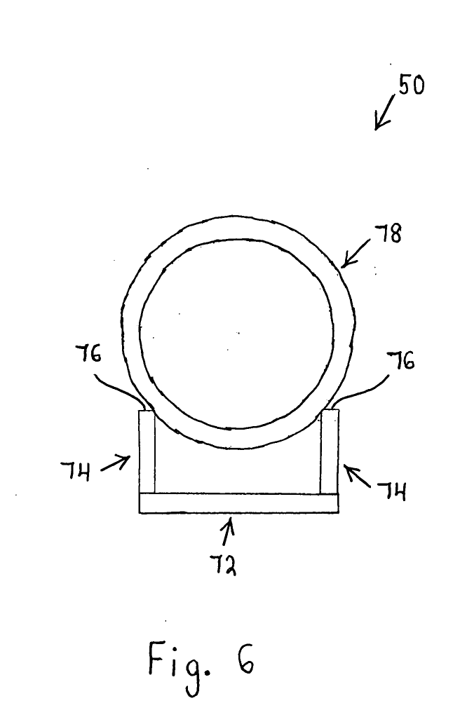

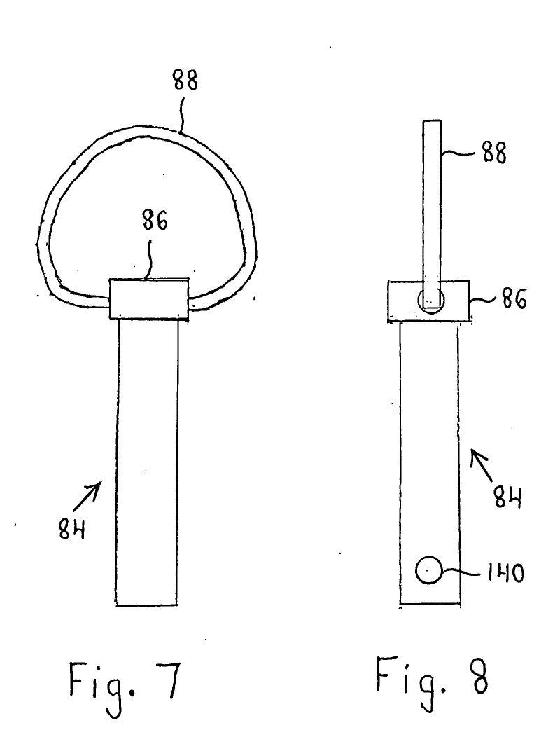

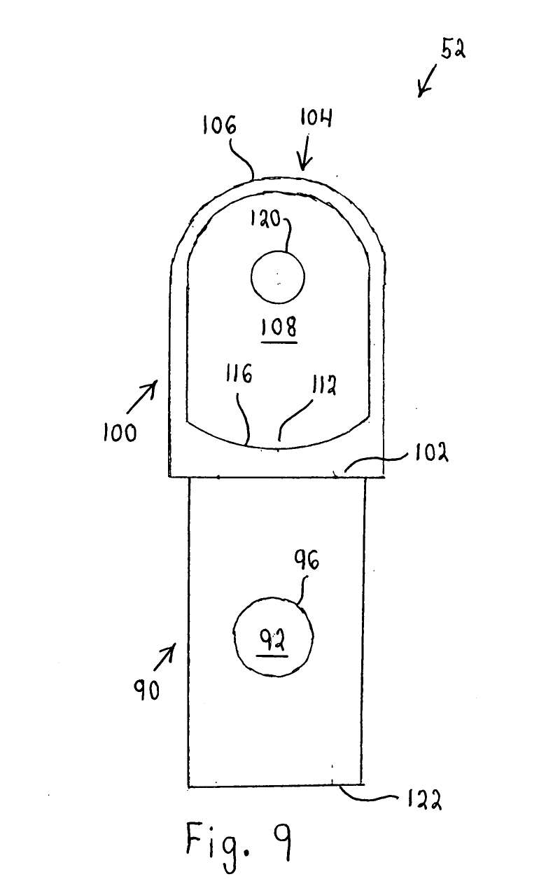

Turning to FIGS. 3-6, the support 50 comprises a holding member or component in the form of a flat rectangular plate 72. Two identical trapezoidal flanges 74 made of flat plate project from one of the major surfaces of the rectangular plate 72 perpendicular to the plate 72. The flanges 74 are parallel to one another, and each of the flanges 74 runs along a respective one of the longer edges of the plate 72. The flanges 74 extend the entire length of the rectangular plate 72, that is, from one longitudinal end of the plate 72 to the other. Each of the flanges 74 has an edge 76 which is parallel to and centered longitudinally of the rectangular plate 72, and the height of the flanges 74 is a maximum along the edges 76. The flanges 74 have a minimum height, which can be zero, at the longitudinal ends of the rectangular plate 72, and the height of the flanges 74 increases linearly or progressively from each longitudinal end of the plate 72 to the edges 76.

The support 50 further comprises a tube or hollow cylinder 78 of circular cross section. The tube 78 is positioned with the external peripheral surface thereof resting on the edges 76 of the flanges 74 and with the axis thereof parallel to and extending longitudinally of the rectangular plate 72. The tube 78 is connected to the flanges 74, e.g., by welds, and the flanges 74 hold the tube 78 at a distance “d” from the rectangular plate 72.

The length of the tube 78 equals or approximates the length of the edges 76, and the tube 78 is centered longitudinally of the rectangular plate 72. The rectangular plate 72 has two portions which project beyond the respective ends of the tube 78, and each of the projecting portions of the plate 72 is provided with a mounting hole 80. The mounting holes 80 can be used to attach the rectangular plate 72, and hence the support 50, to a surface by means of mounting members appropriate for the surface.

Considering FIG. 5, the tube 78 is provided with a pair of diametrically opposed or registering holes 82 (only one of the holes 82 is visible in the drawings). Referring to FIGS. 7 and 8 together with FIG. 5, the holes 82 are sized to receive a locking pin or locking element 84 with a relatively close fit so that the locking pin 84 is held in the holes 82 relatively firmly. The locking pin 84 has a head 86 at one end thereof, and a D-shaped handle 88 is secured to the head 86 and can be used to pull the locking pin 84 from the holes 82.

As mentioned earlier, the system 46 for mounting the tie-out 12 on a surface includes, in addition to the cap 48 and the support 50, a carrier 52 which can be attached to the cap 48 and mounted on the support 50.

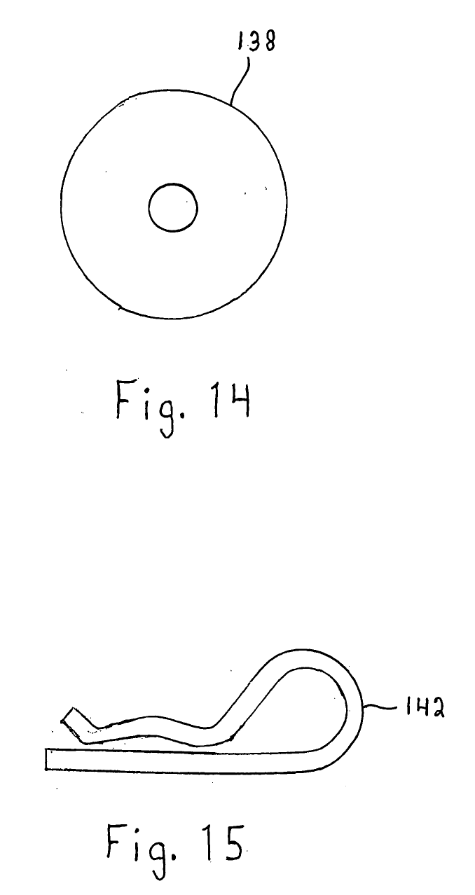

Turning to FIGS. 9-14, the carrier 52 includes a cylindrical shaft 90 which has a solid circular cross section and serves as a pivot. The cylindrical shaft 90 is sized to fit in the tube 78 of the support 50 with just enough play to allow relative rotation of the tube 78 and the cylindrical shaft 90. The cylindrical shaft 90 is formed with two straight channels 92 and 94 which run diametrically of the cylindrical shaft 90. The channels 92,94 are perpendicular to one another and intersect inside the cylindrical shaft 90. The channel 92 has a pair of diametrically opposed or registering openings 96 at the periphery of the cylindrical shaft 90, and the respective axes of the openings 96 lie on a common line inasmuch as the openings 96 are diametrically opposed. Similarly, the channel 94 has a pair of diametrically opposed or registering openings 98 at the periphery of the cylindrical shaft 90 (only one of the openings 98 is visible in the drawings), and the respective axes of the openings 98 again lie on a common line. The channel openings 96,98 are positioned in such a manner that the common line for the axes of the openings 96 and the common line for the axes of the openings 98 intersect at the longitudinal axis of the cylindrical shaft 90, i.e., at the center of the cylindrical shaft 90 as considered diametrically of the shaft 90.

A connecting element 100 is affixed to one longitudinal end of the cylindrical shaft 90. This end of the cylindrical shaft 90 has a flat end face or surface which confronts and is secured to a flat end face or surface formed on the connecting element 100 at a longitudinal end 102 thereof. The flat end face at the longitudinal end 102 of the connecting element 100 projects radially outward of the cylindrical shaft 90. The connecting element 100 has a longitudinal end 104 opposite the longitudinal end 102, and the longitudinal end 104 comprises an end surface 106 which constitutes part of a hemisphere.

The connecting element 100 is provided with a flat front face 108 which lies in a plane perpendicular to the axes of the channel openings 96 and parallel to the axes of the channel openings 98. The connecting element 100 is further provided with a flat rear face 110 which is parallel to and smaller than the flat front face 108.

The flat front face 108 has an end 112 which faces the cylindrical shaft 90 while the flat rear face 110 has an end 114 which faces the cylindrical shaft 90. Although both the end 112 of the flat front face 108 and the end 114 of the flat rear face 110 are spaced from the cylindrical shaft 90, the distance between the cylindrical shaft 90 and the end 112 is smaller than the distance between the cylindrical shaft 90 and the end 114. A curved surface 116 extends outward from the end 112 of the flat front face 108 whereas a curved surface 118 extends outward from the end 114 of the flat rear face 110.

The surfaces of the connecting element 100 other than the partly hemispherical end surface 106, the flat front face 108, the flat rear face 110, the curved surface 116 and the curved surface 118 constitute part of a round cylinder.

The connecting element 100 is provided with a straight passage 120 which runs between the flat front face 108 and the flat rear face 110. The axis of the passage 120 is parallel to the axes of the channel openings 96, and the passage 120 is sized to receive the bolt 60 of FIG. 2 with little play.

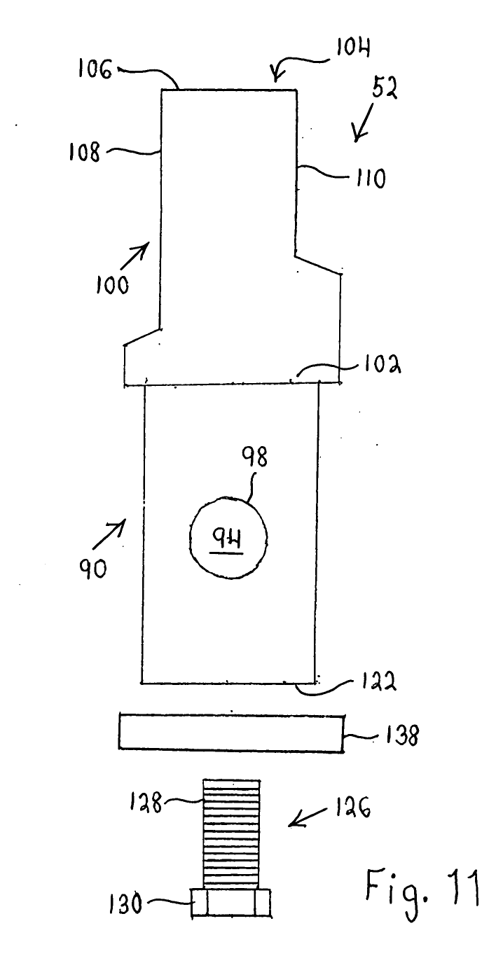

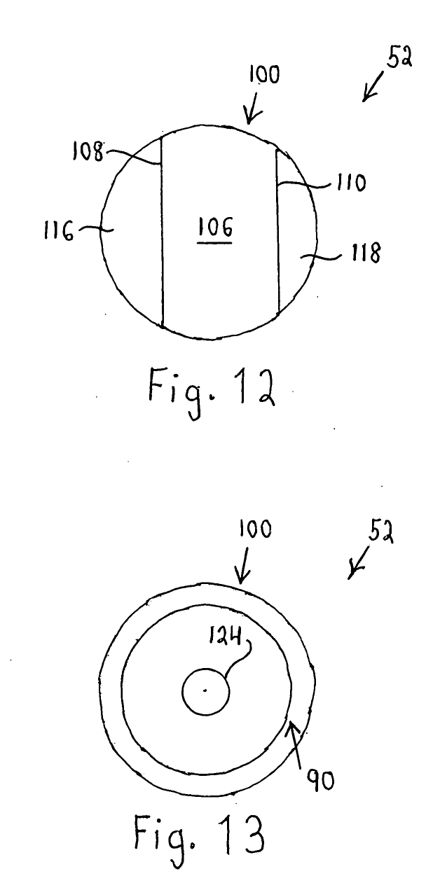

The longitudinal end of the cylindrical shaft 90 remote from the connecting element 100 has a flat end face 122 which is parallel to the flat end face at the longitudinal end 102 of the connecting element 100. As illustrated in FIG. 13, a threaded passage 124 extends into the cylindrical shaft 90 from the flat end face 122 thereof. The threaded passage 124 runs axially of the cylindrical shaft 90 and is designed to receive a bolt 126 which is shown in FIG. 11 and includes a threaded shaft 128 and a head or abutment 130 at one longitudinal end of the shaft 128. The bolt 126 functions as a fastening or tightening element.

Since the shaft 14 of the tie-out 12 is flexible throughout its length, the connection between the tie-out 12 and the system 46 for mounting the tie-out 12 on a surface, as well as the system 46 itself, can be free of springs. Freedom from springs is of advantage when it is desired for a tethering system such as the system 10 to fail at a predetermined stress. While it is difficult to design a spring so as to fail at a given stress, this can be relatively easily accomplished with the flexible shaft 14.

One manner of assembling the mounting system 46 for the tie-out 12 is as follows:

Referring to FIG. 2 in conjunction with FIGS. 9-11, the threaded passage 58 in the cap 48 opens to a flat end face 132 of the cap 48. The flat front face 108 of the carrier 52 is placed against the flat end face 132 of the cap 48 and the passage 120 in the carrier 52 is aligned with the threaded passage 58 in the cap 48. A flat washer or bearing element 134 seen in FIG. 2 is placed against the flat rear face 110 of the carrier 52 and a belleville spring or biasing element 136 also seen in FIG. 2 is thereupon placed against the washer 134. The bolt 60 of FIG. 2 is then passed through the belleville spring 136, the washer 134 and the passage 120 and screwed into the threaded passage 58.

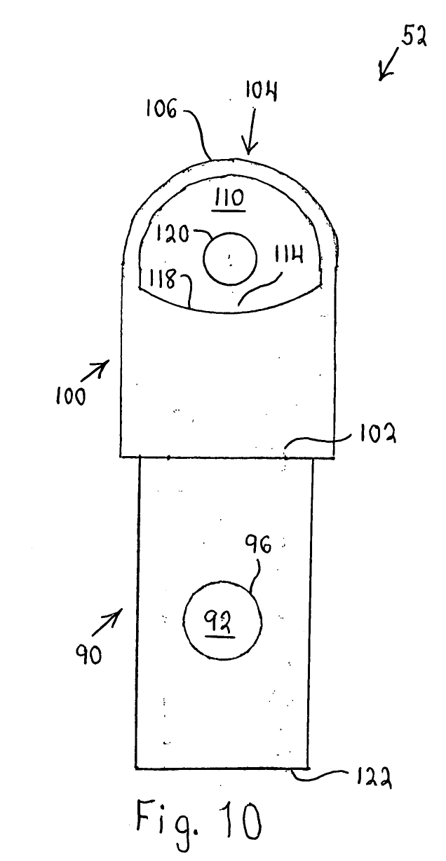

Considering now FIGS. 3, 5 and 6 together with FIGS. 10, 11, 13 and 14, the cylindrical shaft 90 of the carrier 52 is inserted in the tube 78 of the support 50. The width of the connecting element 100 of the carrier 52 exceeds the inner diameter of the tube 78 so that the connecting element 100 is unable to enter the tube 78. As mentioned previously, the flat end face at the longitudinal end 102 of the connecting element 100 projects radially outward of the cylindrical shaft 90, and at least part of the radially outward projecting end face rests against an end face of the tube 78.

The length of the cylindrical shaft 90 is equal to or somewhat less than the length of the tube 78. Thus, when the cylindrical shaft 90 is received in the tube 78, a flat washer or bearing element 138 made of plate can be placed against the end face of the tube 78 which faces away from the connecting element 100. The flat end face 122 of the cylindrical shaft 90 is located adjacent to or near such end face of the tube 78 so that the bolt 126 of FIG. 11 can be passed through the washer 138 and screwed into the threaded passage 124 which extends away from the flat end face 122. The head 130 of the bolt 126 bears against the washer 138 which is located between the head 130 and the carrier 52. Upon tightening the bolt 126, the flat end face at the longitudinal end 102 of the connecting element 100 is urged against the adjacent end face of the tube 78.

After the bolts 60 and 126 have been tightened, the support 50 can be attached to a surface by passing mounting members appropriate for the surface through the mounting holes 80 of the support 50.

The washer 138 allows the mounting system 46 for the tie-out 12 to be tightened in such a way that vibrations, as well as rattles and other noises, caused by a moving animal are virtually eliminated. Such vibrations and noises, which typically arise from metal-to-metal contact, can result in loss of sleep when, for instance, an animal is tethered to a trailer with living quarters.

The resilience of the shaft 14 allows the latter to flex or bend to a substantial degree without cracking or snapping when stressed by an animal tethered to the tie-out 12 so that the animal has additional freedom of movement.

The stretchable tether 32 permits an animal to be tied at a substantial distance, e.g., 24 inches, above the ground while still allowing the animal to have access to food and water. By way of example, the tether 32 can be designed to stretch from a length of 5 feet to a length of 9 feet. Moreover, the stretchable nature of the tether 32 makes it possible to keep the tether 32 out of an animal's way when the animal rolls, eats or rests.

Considering once more FIGS. 5 and 9-11, the channel 92 in the cylindrical shaft 90 of the carrier 52 can be aligned with the holes 82 in the tube 78 once the cylindrical shaft 90 has been placed in the tube 78. Upon alignment of the channel 92 and the holes 82, the locking pin 84 of FIGS. 7 and 8 can be inserted in the holes 82 and the channel 92. As shown in FIG. 8, the end of the locking pin 84 remote from the handle 88 is provided with a passage 140, and the length of the locking pin 84 is such that this end of the locking pin 84 projects from the tube 78 when the locking pin 84 is properly situated in the holes 82 and the channel 92. This enables a cotter pin or arresting element 142 illustrated in FIG. 15 to be passed through the passage 140 thereby preventing the locking pin 84 from being pulled out of the holes 82 and the channel 92.

When the holes 82 and the channel 92 are in register and the tie-out 12 is supported on a vertical surface, the tie-out 12 projects from the vertical surface perpendicular thereto. Since the locking pin 84 prevents the cylindrical shaft 90 from rotating relative to the tube 78, the tie-out 12 is fixed in this position so that the tether 32 is some distance, e.g., 4 feet, from the vertical surface. This gives the animal room to move in all directions.

Upon removal of the cotter pin 142 from the passage 140 in the locking pin 84, the locking pin 84 can be withdrawn from the holes 82 in the tube 78 and the channel 92 in the carrier 52. The cylindrical shaft 90 of the carrier 52 can now be rotated in the tube 78 to bring the channel 94 in the carrier 52 into register with the holes 82. The locking pin 84 can now be inserted in the holes 82 and the channel 94, and the locking pin 84 can then be immobilized via the cotter pin 142.

When the holes 82 and the channel 94 are in alignment and the tie-out 12 is mounted on a vertical surface, the tie-out 12 lies against the vertical surface. A position in which the tie-out 12 lies against a vertical surface is useful where the tie-out 12 is supported on a mobile unit such as a trailer since the mobile unit can travel with the tie-out 12 in this position and there is no need to detach the tie-out 12 from the mobile unit.

The tethering arrangement 10 is designed so that, when the tie-out 12 is mounted on a vertical surface, the cylindrical shaft 90 of the carrier 52 and the tube 78 of the support 50 define a vertical pivot axis for the tie-out 12. However, the tethering arrangement 10 could also be designed to allow pivotal movement of the tie-out 12 on another axis, e.g., a horizontal axis.

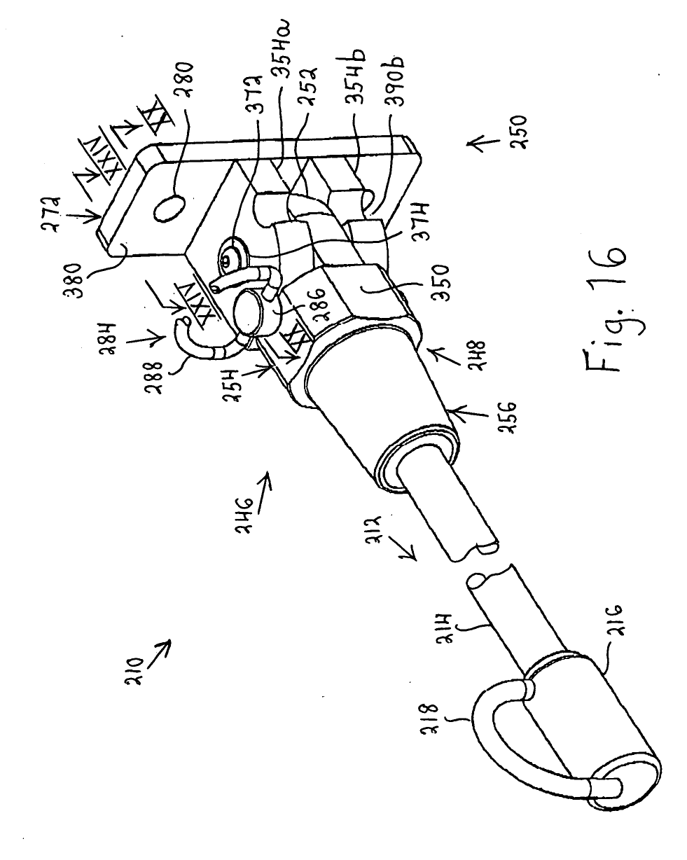

Another embodiment of a tethering arrangement in accordance with the invention is shown in FIGS. 16-24 where the same reference numerals as before, plus 200, are used to identify similar elements. The tie-out 212 of the tethering arrangement 210, which is depicted in FIGS. 16-18, is identical to the tie-out 12 of the tethering arrangement 10. Similarly, the non-illustrated system for attaching the tie-out 212 to an animal is here identical to the attaching system 22 of the tethering arrangement 10, and the tethering arrangement 210 differs from the tethering arrangement 10 mainly in the design of the system 246 for mounting the tie-out 212 on a surface.

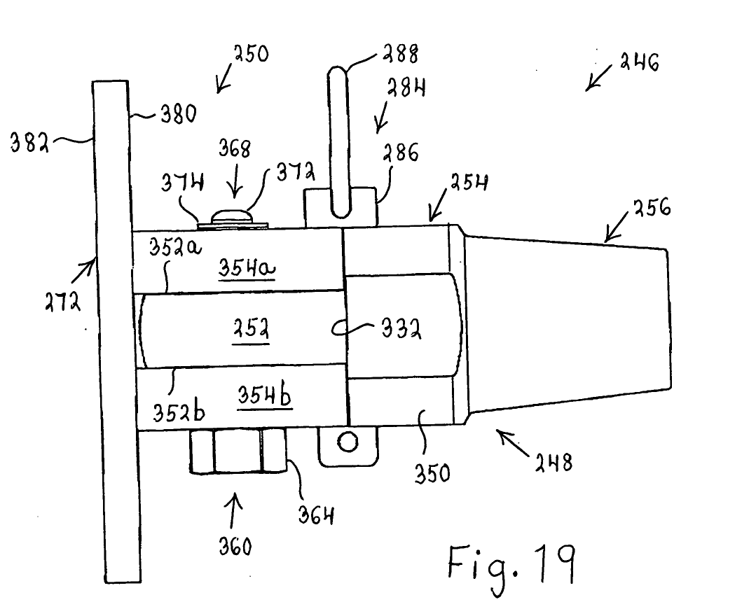

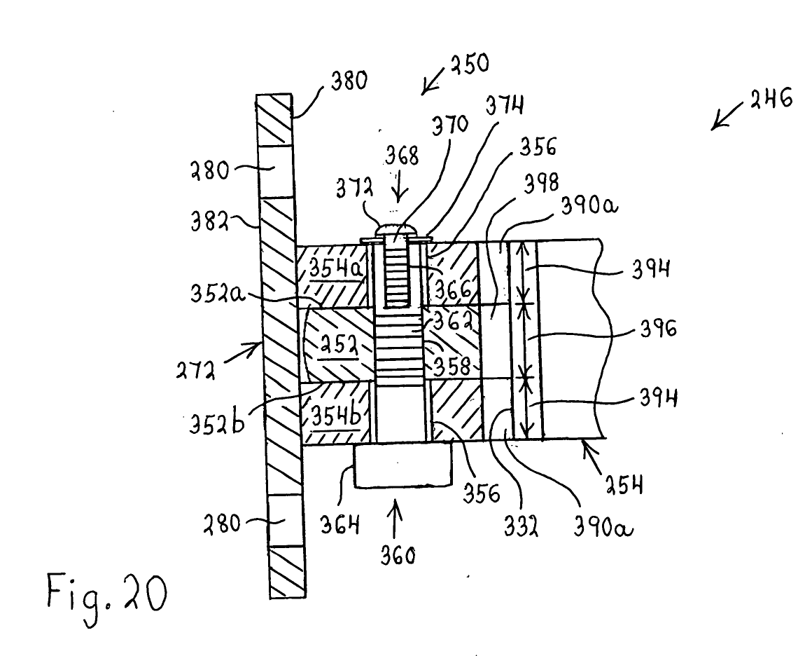

Considering FIGS. 19 and 20, while the section 54 of the cap 48 in the tethering arrangement 10 is a cylinder of circular cross section, the section 254 of the cap or housing 248 in the tethering arrangement 210 is formed with a multiplicity of faces 350. Furthermore, the section 254 of the cap 248 has a solid cross section and lacks the threaded passage 58 in the cap 48. Moreover, the bolt 60, the washer 134 and the belleville spring 136 used to connect the carrier 52 to the cap 48 of the tethering arrangement 10 are not present in the tethering arrangement 210.

The carrier 52 of the tethering arrangement 10, which is discrete from the cap 48, is replaced in the tethering arrangement 210 by a carrier or mounting element 252 integral with the cap 248. The carrier 252 is fast with and extends from the flat end face 332 of the cap 248, and the carrier 252 is in the form of a flat plate having parallel, oppositely directed, planar major surfaces 352a and 352b.

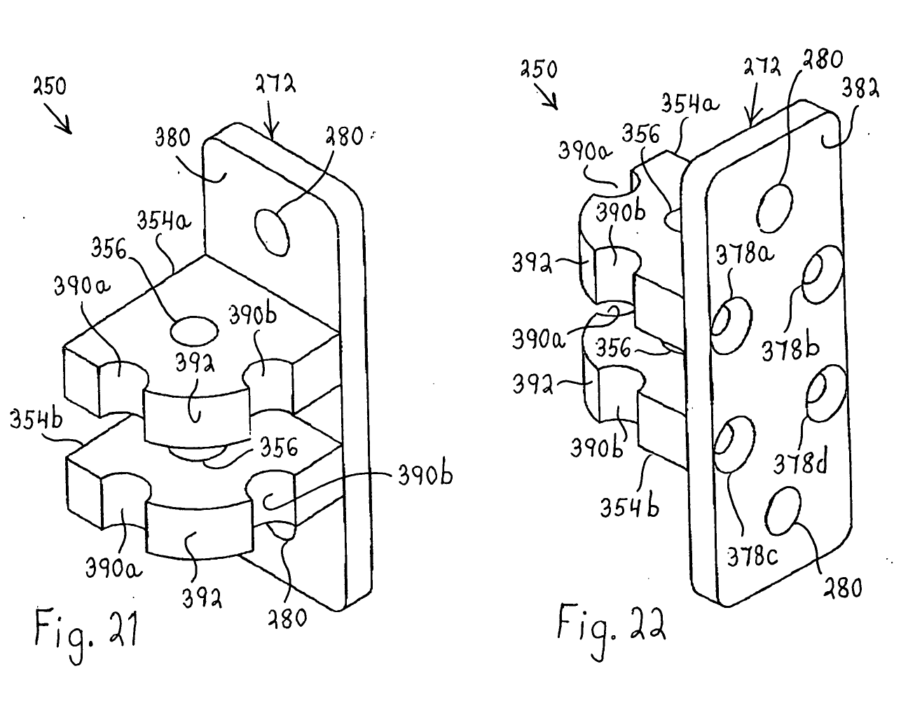

Referring to FIGS. 21-23 in conjunction with FIGS. 19 and 20, the support 50 of the tethering arrangement 10 is replaced in the tethering arrangement 210 by a support or mounting element 250 which includes a holding member or component constituted by a flat rectangular plate 272. The trapezoidal flanges 74 and the tube 78 of the support 50 are eliminated in the support 250 which instead includes two carrying members or components in the form of flat plates 354a and 354b. The holding member 272 has opposite major surfaces 380 and 382, and the carrying members 354a,354b are mounted on, and are perpendicular to, the major surface 380. Furthermore, the carrying members 354a,354b are arranged so that a major surface of each carrying member 354a,354b faces and is parallel to a major surface of the other carrying member 354a,354b.

The carrying members 354a,354b are spaced from each other and define a gap having a thickness slightly larger than the thickness of the carrier 252. In the assembled condition of the tethering arrangement 210, the carrier 252 is located in the gap with the major surface 352a of the carrier 252 confronting the carrying member 354a and the major surface 352b confronting the carrying member 354b.

Each of the carrying members 354a,354b is provided with an opening 356 whose axis is perpendicular to the major surfaces of the carrying members 354a,354b, and the openings 356 are in register with one another. The carrier 252 is likewise formed with an opening 358 having an axis which is perpendicular to the major surfaces 352a,352b of the carrier 252, and the opening 358 is threaded. When the tethering arrangement 210 is assembled, the opening 358 in the carrier 252 is in register with the openings 356 in the carrying members 354a,354b.

Considering FIG. 20, the registering openings 356,358 are designed to receive a clamping or tightening element which is here constituted by a bolt 360 having a threaded shaft 362 and a head or abutment 364 at one end of the shaft 362. The length of the shaft 362 is equal or approximately equal to the distance between the major surface of the carrying member 354a which faces away from the carrier 252 and the major surface of the carrying member 354b which faces away from the carrier 252. The shaft 362 of the clamping bolt 360 is arranged to be screwed into the threaded opening 358 of the carrier 252 and to be received in the openings 356 of the carrying members 354a,354b with a certain amount of radial clearance.

When the shaft 362 of the clamping bolt 360 is inserted into the opening 356 of one of the carrying members 354a,354b and screwed into the threaded opening 358 of the carrier 252, the head 364 of the bolt 360 comes to rest against this carrying member 354a,354b. The end of the shaft 362 remote from the head 364 is then located in the opening 356 of the other carrying member 354a,354b and, as the clamping bolt 360 is tightened, the carrier 252 is drawn against such carrying member 354a,354b. Drawing of the carrier 252 against one of the carrying members 354a,354b allows vibrations, as well as rattles and other noises, caused by a moving animal to be virtually eliminated.

In FIG. 20, the head 364 of the clamping bolt 360 bears against the carrying member 354b while the end of the shaft 362 remote from the head 364 is located in the opening 356 of the carrying member 354a.

The end of the shaft 362 remote from the head 364 is provided with a threaded passage or hole 366 which extends axially of the shaft 362. A retaining or holding element is screwed into the threaded passage of the shaft 362, and such retaining or holding element here takes the form of a bolt 368 having a threaded shaft 370 and a head or abutment 372 at one end of the shaft 370. The shaft 370 passes through a washer 374 which rests against the carrying member 354a and the head 372 bears on the washer 372. The retaining bolt 368 inhibits or prevents the clamping bolt 360 from becoming loose and falling out as a result of vibrations, and the retaining bolt 368 can accordingly be considered a means for inhibiting or preventing loss of the connection between the carrier 252 and the carrying members 354a,354b.

The clamping bolt 360 forms a pivot which allows the carrier 252 to rotate relative to the carrying members 354a,354b.

The carrying members 354a,354b are discrete from the holding member 272 and can be detached therefrom and reattached thereto. Each of the carrying members 354a,354b has a flat edge which lies against the major surface 380 of the holding member 272 when the carrying members 354a,354b are mounted on the holding member 272, and a pair of spaced, threaded passages or attachment elements extends inward from such flat edge of each carrying member 354a,354b. The two threaded passages in the carrying member 354a and the two threaded passages in the carrying member 354b have the same center-to-center distance. One of the threaded passages in each of the carrying members 354a,354b is visible in FIG. 24, and the passages are denoted by 376.

Turning to FIG. 22 in conjunction with FIG. 24, the holding member 272 is provided with four holes or attachment elements 378a, 378b, 378c and 378d which extend from the major surface 380 to the major surface 382 of the holding member 272. The holes 378a-378d are arranged at the corners of a square whose sides are parallel to the sides of the holding member 272, and the two holes 378a-378d along each side of the square have the same center-to-center distance as the two threaded passages 376 in each of the carrying members 354a,354b. The two holes 378a;378b define a line which is parallel to the shorter sides of the holding member 272 and the same is true for the two holes 378c,378d. On the other hand, the two holes 378a,378c define a line which is parallel to the longer sides of the holding member 272 as do the two holes 378b,378d. Hence, the pair of holes 378a,378b and the pair of holes 378c,378d can be considered to have one orientation while the pair of holes 378a,378c and the pair of holes 378b,378d can be considered to have another orientation.

Each of the holes 378a-378d has a tapered portion which extends from the major surface 382 of the holding member 272 partway to the major surface 380 and narrows in a direction away from the major surface 382. Each of the holes 378a-378d further has a portion of constant cross section which bridges the respective tapered portion and the major surface 380 of the holding member 272.

When the carrying members 354a,354b are mounted on the holding member 272, the two threaded passages 376 in one of the carrying members 354a,354b are aligned with two of the holes 378a-378d in the holding member 272 and the two threaded passages 376 in the other of the carrying members 354a,354b are aligned with the two remaining holes 378a-378d. The portions of the holes 378a-378d which have a constant cross section adjoin the threaded passages 376. The threaded passages 376 and the respective aligned holes 378a-378d are designed to receive fastening or joining elements in the form of bolts 384 (only two of the bolts 384 are visible in the drawings), and each of the fastening bolts 384 has a threaded shaft 386 and a tapered head 388 at one end of the respective shaft 386. The threaded shafts 386 screw into the threaded passages 376 of the carrying members 354a,354b while the tapered heads 388 fit in the tapered portions of the holes 378a-378d. The bolts 384 serve to releasably secure the carrying members 354a,354b to the holding member 272.

The placement of the holes 378a-378d at the corners of a square allows the carrying members 354a,354b to be mounted on the holding member 272 in different orientations relative to the holding member 272. In FIGS. 16, 17, 21 and 22, the threaded passages 376 of the carrying member 354a are aligned with the holes 378a,378b of the holding member 272 and the threaded passages 376 of the carrying member 354b are aligned with the holes 378c,378d. The major surfaces of the carrying members 354a,354b are here located in planes which are perpendicular to the longer edges of the holding member 272 and, when the holding member 272 is attached to a surface such that the longer edges thereof run vertically, the carrying members 354a,354b support the tie-out 212 for pivotal or rotational movement in a horizontal plane.

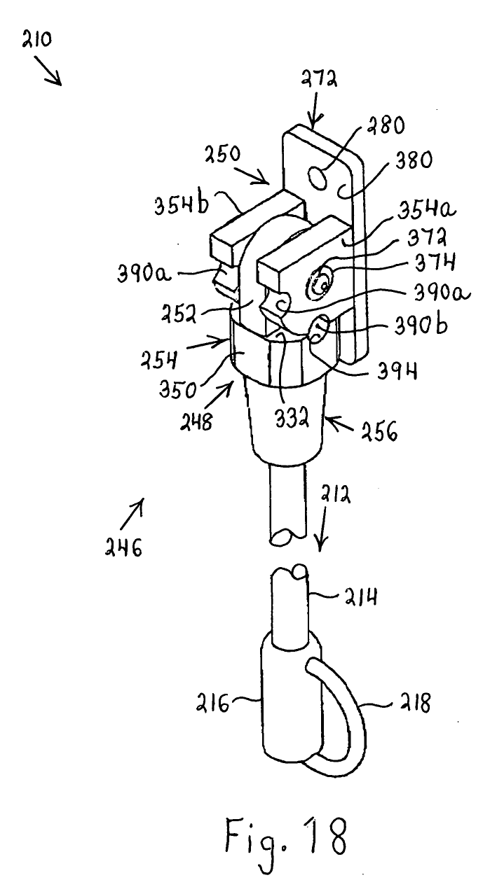

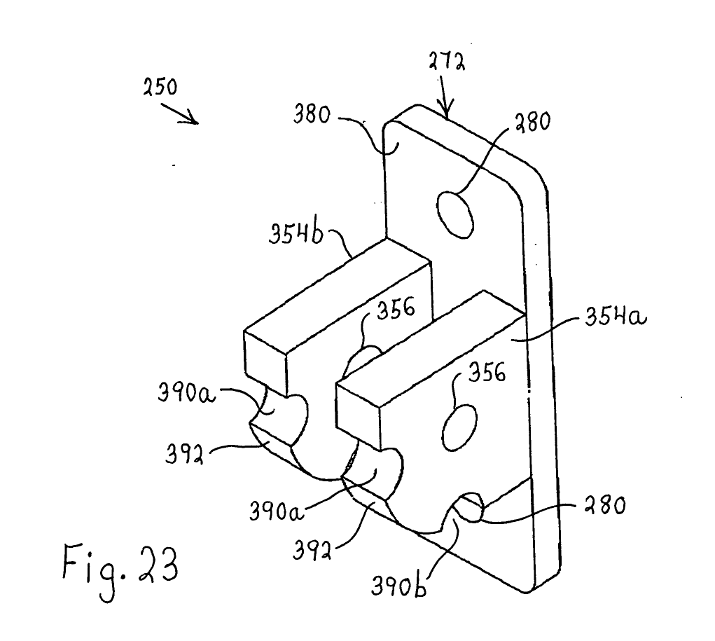

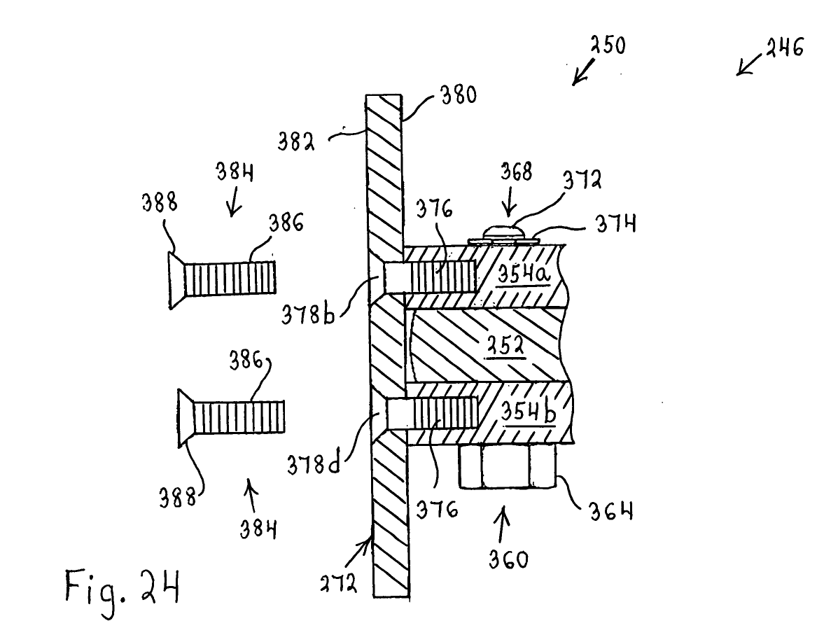

Considering FIGS. 18 and 23, the threaded passages 376 of the carrying member 354a are aligned with the holes 378a,378c of the holding member 272 while the threaded passages 376 of the carrying member 354b are aligned with the holes 378b,378d. The major surfaces of the carrying members 354a,354b are now located in planes which are perpendicular to the shorter edges of the holding member 272 and, when the holding member 272 is mounted on a surface with the longer edges of the holding member 272 extending vertically as before, the carrying members 354a,354b support the tie-out 212 for pivotal or rotational movement in a vertical plane.

Referring to FIGS. 21-23, each of the carrying members 354a,354b has an edge which is remote from the flat edge thereof having the threaded passages 376 and is formed with a semicircular notch or cutout 390a. Each of the carrying members 354a,354b further has an edge which intersects the flat edge with the threaded passages 376 and is provided with a semicircular notch or cutout 390b identical to the notches 390a. The notch 390a in each carrying member 354a,354b is rotated 90 degrees with respect to the notch 390b in the respective carrying member 354a,354b, and the two notches 390a,390b in each carrying member 354a,354b are spanned by a part-circular edge face 392 of the respective carrying member 354a,354b.

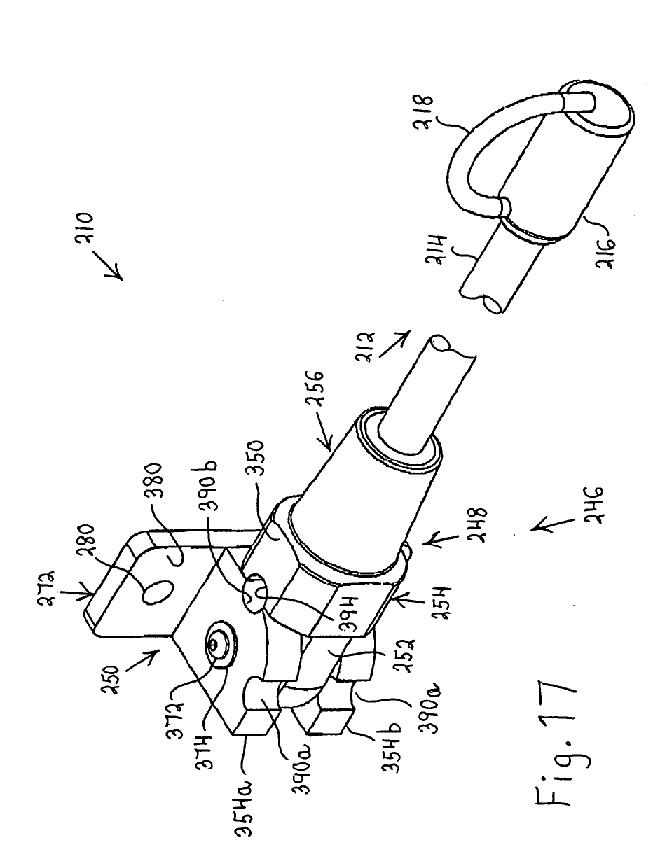

Turning to FIGS. 17, 18 and 20, the flat end face 332 of the cap 248 confronts the carrying members 354a,354b in the assembled condition of the tethering arrangement 210. As indicated previously, the carrier 252 projects from the flat end face 332, and the flat end face 332 is formed with a semicircular notch or cutout 394 which extends diametrically across the flat end face 332. The notch in the flat end face 332 has two portions 394 which project to either side of the carrier 252 and a central portion 396 which faces the carrier 252 and is located between the projecting notch portions 394. The carrier 252 is provided with a semicircular notch or cutout 398 which confronts the central notch portion 396 and cooperates therewith to define a circular opening.

The tie-out 212 is rotatable through 90 degrees between two terminal positions. In one terminal position, the projecting notch portions 394 of the cap 248 directly face the two notches 390a in the respective carrying members 354a,354b. This terminal position is an extended or operative position of the tie-out 212 in which the tie-out 212 extends normal to a surface supporting the holding member 272. The extended position of the tie-out 212, illustrated in FIG. 16, is the position in which an animal is normally tethered to the tie-out 212.

In the second terminal position of the tie-out 212, the projecting notch portions 394 of the cap 248 directly face the two notches 390b in the respective carrying members 354a,354b. Such terminal position constitutes a retracted or inoperative position of the tie-out 212 in which the tie-out 212 is parallel and adjacent to a surface supporting the holding member 272. The retracted position of the tie-out 212, shown in FIGS. 17 and 18, may be considered a storage position.

The projecting notch portions 394 of the cap 248 are arranged so that, when the tie-out 212 is in its extended and retracted positions, the projecting notch portions 394 directly face the notches 390a,390b in the carrying members 354a,354b and cooperate with the notches 390a,390b to define circular openings. This is illustrated in FIGS. 17 and 18 where the tie-out 212 is in the retracted position. In both the extended and retracted positions of the tie-out 212, the openings defined by the projecting notch portions 394 and the notches 390a or 390b are in register with the opening defined by the central notch portion 396 of the cap 248 and the notch 398 of the carrier 252. The tie-out 212 can be locked in either the extended or retracted position by inserting the locking pin 284 in the registering openings as shown in FIG. 16.

One manner of assembling the mounting system 246 for the tie-out 212 is as follows:

The flat edge of the carrying member 354a containing the open ends of the respective threaded passages 376 is placed against the major surface 380 of the holding member 272. The two threaded passages 376 in the carrying member 354a are brought into register with two of the holes 378a-378d in the holding member 272, and the carrying member 354a is secured to the holding member 272 by screwing a bolt 384 into each of the threaded passages 376 thereof via the respective registering holes 378a-378d.

Similarly, the flat edge of the carrying member 354b containing the open ends of the associated threaded passages 376 is placed against the major surface 380 of the holding member 272 and positioned so that the threaded passages 376 are in register with the two unoccupied holes 378a-378d in the holding member 272. The carrying member 354b is secured to the holding member 272 by screwing a bolt 384 into each of the threaded passages 376 of the carrying member 354b via the respective registering holes 378a-378d.

The carrier 252 is placed between the carrying members 354a,354b and adjusted in such a manner that the threaded passage 358 of the carrier 252 comes into alignment with the openings 356 in the carrying members 354a,354b. The clamping bolt 360 is screwed into the threaded passage 358 and tightened so that the head 364 of the bolt 360 is urged against one of the carrying members 354a,354b and the carrier 252 is urged against the other of the carrying members 354a,354b. Such tightening of the bolt 360 allows vibrations, as well as rattles and other noises, caused by a moving animal to be reduced or eliminated.

Once the clamping bolt 360 has been tightened, the shaft 370 of the retaining bolt 368 is passed through the washer 374 and screwed into the threaded passage 366 which is formed in the end of the clamping bolt 360 remote from the head 364 thereof. The retaining bolt 368 is tightened to urge the head 372 of the bolt 368 against the washer 374 which, in turn, is urged towards the end of the bolt 360 containing the threaded passage 366. This end of the bolt 360 is located in the opening 356 of one of the carrying members 354a,354b, and the washer 374 can abut and be urged against such carrying member 354a,354b.

The mounting system 246 can be attached to a supporting surface such as the side of a trailer or a wall. To this end, the major surface 382 of the holding member 272 is placed against the supporting surface and mounting members appropriate for the supporting surface are passed through the mounting holes 280 of the holding member 272.

Assuming that the tie-out 212 is locked in the retracted or storage position, the projecting notch portions 394 in the cap 248 face the notches 390b in the carrying members 354a,354b and cooperate with the notches 390b to define openings which are in register with the opening defined by the central notch portion 396 of the cap 248 and the notch 398 of the carrier 252. The tie-out 212 is parallel and adjacent to the surface supporting the holding member 272, and the locking pin 284 passes through the registering openings to prevent the tie-out 212 from rotating.

If it is desired to move the tie-out 212 to its extended position, the locking pin 284 is removed from the registering openings in the cap 248, the carrier 252 and the carrying members 354a,354b. The tie-out 212 is rotated 90 degrees to bring the tie-out 212 into the extended position in which the tie-out 212 is perpendicular to the surface supporting the holding member 272. In the extended position of the tie-out 212, the projecting notch portions 394 in the cap 248 face the notches 390a in the carrying members 354a,354b and cooperate with the notches 390a to define openings which are in register with the opening defined by the central notch portion 396 of the cap 248 and the notch 398 of the carrier 252. The tie-out 212 can be locked in the extended position by inserting the locking pin 284 in the registering openings.

If the tie-out 212 was locked in the extended position and is to be returned to the retracted position, the locking pin 284 is removed from the registering openings in the cap 248, the carrier 252 and the carrying members 354a,354b. The tie-out 212 is then rotated 90 degrees into a position of parallelism with the surface supporting the holding member 272.

The retaining bolt 368, or both the retaining bolt 368 and the clamping bolt 360, may need to be loosened in order to permit rotation of the tie-out 212.

Assuming that the carrying members 354a,354b are mounted on the holding member 272 with the major surfaces of the carrying members 354a,354b located in planes which are perpendicular to the longer edges of the holding member 272, the threaded passages 376 in the carrying member 354a are in register with the holes 378a,378b in the holding member 272 and the threaded passages 376 in the carrying member 354b are in register with the holes 378c,378d in the holding member 272. If it is desired to change the orientation of the carrying members 354a,354b relative to the holding member 272, the bolts 384 are removed from the threaded passages 376 and the holes 378a-378d. The threaded passages 376 in the carrying member 354a are placed in register with the holes 378a,378c in the holding member 272 and a bolt 384 is screwed into each of the threaded passages 376 of the carrying member 354a via the respective holes 378a,378c. The carrying member 354a is now attached to the holding member 272 with the major surfaces of the carrying member 354a located in planes perpendicular to the shorter edges of the holding member 272.

The threaded passages 376 in the carrying member 354b, on the other hand, are placed in register with the holes 378b,378d in the holding member 272. A bolt 384 is thereupon screwed into each of the threaded passages 376 of the carrying member 354b by way of the registering holes 378b,378d. Accordingly, the carrying member 354b is secured to the holding member 272 with the major surfaces of the carrying member 354b located in planes which are perpendicular to the shorter edges of the holding member 272.

Various modifications are possible within the meaning and range of equivalence of the appended claims.

I claim:

1. An arrangement for confining an animal comprising:
a shaft for connection to the animal to restrict movement of the animal;
means for mounting said shaft on a surface, said mounting means including a first mounting element for attachment to the surface and a second mounting element designed to support said shaft and to be supported by said first mounting element; and
means for securing said second mounting element to said first mounting element, said securing means comprising a tightening element for urging said first mounting element and said second mounting element against each other.

2. The arrangement of claim 1, wherein said tightening element defines a pivot for relative rotation of said first mounting element and said second mounting element.

3. The arrangement of claim 1, wherein one of said mounting elements comprises a pair of spaced carrying members which define a gap and at least part of the other of said mounting elements is receivable in said gap, at least one of said carrying members being provided with an opening and said part of said other mounting element being provided with a threaded passage capable of being aligned with said opening, said tightening element including a threaded shaft designed to extend through said opening and screw into said passage.

4. The arrangement of claim 3, wherein said shaft is provided with a head which is arranged to bear on said at least one carrying member when said shaft extends through said opening and into said passage.

5. The arrangement of claim 3, wherein said shaft is provided with a threaded hole; and further comprising a threaded retaining element designed to screw into said hole and secure said shaft to said at least one carrying member.

6. The arrangement of claim 5, wherein said retaining element is provided with a head which is arranged to bear on said at least one carrying member when said shaft extends through said opening and into said passage and said retaining element is screwed into said hole.

7. The arrangement of claim 1, wherein one of said mounting elements comprises a tubular portion of circular cross section and the other of said mounting elements comprises a cylindrical portion of circular cross section, said cylindrical portion being receivable in said tubular portion such that said tubular portion and said cylindrical portion are rotatable relative to one another, and one of said portions being provided with a radially projecting surface, said tightening element being designed to urge said radially projecting surface and the other of said portions against each other.

8. The arrangement of claim 7, wherein said cylindrical portion is provided with a threaded passage and said tightening element comprises a threaded shaft designed to screw into said passage.

9. The arrangement of claim 8, wherein said shaft is provided with a head; and further comprising a washer designed to be interposed between said head and at least one of said portions.

10. An arrangement for confining an animal comprising:
a shaft for connection to the animal to restrict movement of the animal; and
means for mounting said shaft on a surface, said shaft being resilient.

11. The arrangement of claim 10, wherein said shaft comprises fiberglass.

12. The arrangement of claim 10, further comprising means for attaching said shaft to said mounting means, said attaching means being devoid of springs.

13. An arrangement for confining an animal comprising:
a shaft for connection to the animal to restrict movement of the animal;
means for mounting said shaft on a surface, said shaft having a first end for connection to the animal and a second end designed to be held by said mounting means, and said mounting means including a housing for said second end, said housing having an opening and said shaft projecting from said housing through said opening; and
a flexible body between a portion of said second end and a portion of said housing.

14. The arrangement of claim 13, wherein said body comprises plastic.

15. The arrangement of claim 14, wherein said body comprises polyurethane.

16. An arrangement for confining an animal comprising:
a shaft for connection to the animal to restrict movement of the animal;
means for mounting said shaft on a surface, said mounting means being designed to support said shaft for movement between a first position and a second position, and said mounting means including a first mounting element for attachment to the surface and a second mounting element designed to support said shaft and to be movably supported by said first mounting element; and
means for locking said shaft in said first position and in said second position, said locking means comprising a locking element designed to bridge said first mounting element and said second mounting element.

17. The arrangement of claim 16, wherein said locking means comprises at least one cutout in one of said mounting elements and at least one opening in the other of said mounting elements, said at least one cutout and said at least one opening being relatively movable into and out of a predetermined position in which said at least one cutout is aligned with said at least one opening, and said at least one cutout and said at least one opening being in said predetermined position when said shaft is in said first position, said locking element being insertable in said at least one cutout and said at least one opening upon alignment thereof.

18. The arrangement of claim 17, wherein said locking means comprises an additional cutout in said one mounting element and said additional cutout and said at least one opening being relatively movable into and out of an additional position in which said additional cutout is aligned with said at least one opening, said additional cutout and said at least one opening being in said additional position when said shaft is in said second position.

19. The arrangement of claim 16, wherein said locking means comprises a pair of openings in one of said mounting elements and at least one channel in the other of said mounting elements, said openings having a common axis, and said openings and said at least one channel being relatively movable into and out of a predetermined position in which said openings are aligned with said at least one channel, said openings and said at least one channel being in said predetermined position when said shaft is in said first position, and said locking element being insertable in said openings and said at least one channel upon alignment thereof.

20. The arrangement of claim 19, wherein said locking means comprises an additional channel in said other mounting element and said channels extend transverse to one another, said openings and said additional channel being relatively movable into and out of an additional position in which said openings are aligned with said additional channel, and said openings and said additional channel being in said additional position when said shaft is in said second position.

21. An arrangement for confining an animal comprising:
a shaft for connection to the animal to restrict movement of the animal; and
means for mounting said shaft on a surface, said mounting means including a mounting element having a holding member for attachment to the surface and a carrying member designed to be supported by said holding member and to support said shaft for movement, said carrying member being attachable to said holding member in at least two different orientations to permit movement of said shaft in different directions.

22. The arrangement of claim 21, wherein one of said holding member and said carrying member is provided with a first pair of attachment elements and the other of said holding member and said carrying member is provided with a second pair of attachment elements and a differently oriented third pair of attachment elements, said first pair of attachment elements being designed to register with both said second pair of attachment elements and said third pair of attachment elements.

23. The arrangement of claim 22, wherein said second pair of attachment elements lies on a first line and said third pair of attachment elements lies on a second line which is substantially perpendicular to said first line.

24. The arrangement of claim 22, wherein said attachment elements comprise holes.

25. An arrangement for confining an animal comprising:
a shaft for connection to the animal to restrict movement of the animal;
means for mounting said shaft on a surface; and
a stretchable lead for connection to said shaft and to the animal.

26. The arrangement of claim 25, wherein said lead comprises a bungee cord.

27. The arrangement of claim 25, further comprising a flexible extension for connection to said lead and to the animal.

28. An arrangement for confining an animal comprising:
a shaft for connection to the animal to restrict movement of the animal;
means for mounting said shaft on a surface, said mounting means including a first mounting element for attachment to the surface and a second mounting element designed to support said shaft and to be supported by said first mounting element;
means for securing said second mounting element to said first mounting element, said securing means comprising a tightening element for establishing a connection between said first mounting element and said second mounting element; and
means for inhibiting loss of said connection, said inhibiting means including a holding element for holding said tightening element.

29. The arrangement of claim 28, wherein said tightening element is provided with a passage and said holding element is receivable in said passage.

30. The arrangement of claim 28, wherein said holding element is designed to engage said tightening element and to bear on one of said mounting elements.

31. A method of making an arrangement for the confinement of an animal, said method comprising the steps of:
attaching a shaft designed to restrict movement of the animal to a mounting element designed to support said shaft; and
securing said mounting element to another mounting element designed to be attached to a surface, the securing step including urging said mounting elements against each other.

32. A method of making an arrangement for the confinement of an animal, said method comprising the steps of:
providing a housing having an opening;
providing a shaft designed to restrict movement of the animal; and
assembling said housing and said shaft so that one portion of said shaft is located in said housing and another portion of said shaft is located externally of said housing, the assembling step including interposing a flexible body between a portion of said housing and said one portion of said shaft.

33. A method of making an arrangement for the confinement of an animal, said method comprising the steps of:
attaching a shaft designed to restrict movement of the animal to a mounting element designed to support said shaft;
securing said mounting element to another mounting element designed to be attached to a surface, the securing step including establishing a connection between said mounting elements using a tightening element; and
inhibiting loss of said connection, the inhibiting step including holding said tightening element with a holding element.

34. A method of operating an arrangement for the confinement of an animal, said arrangement including a shaft for restricting movement of the animal, and said method comprising the steps of:
attaching the animal to said shaft; and
flexing said shaft.

35. A method of operating an arrangement for the confinement of animal, said arrangement including a shaft for restricting movement of the animal, a first mounting element attached to a surface and a second mounting element which supports said shaft and is movably supported by said first mounting element, said method comprising the steps of:
moving said second mounting element and said shaft to a first position;
locking said second mounting element and said shaft in said first position by bridging said first mounting element and said second mounting element with a locking element;
removing said locking element;
moving said second mounting element and said shaft to a second position; and
locking said second mounting element and said shaft in said second position by bridging said first mounting element and said second mounting element with said locking element.

36. A method of operating an arrangement for the confinement of an animal, said arrangement including a shaft for restricting movement of the animal, and a mounting element having a holding member attached to a surface and a carrying member supported by said holding member and movably supporting said shaft, said method comprising the step of:
changing the orientation of said carrying member on said holding member.

37. A method of operating an arrangement for the confinement of an animal, said arrangement including a shaft for restricting movement of the animal and a lead connected to said shaft, and said method comprising the steps of:
attaching the animal to said lead; and
stretching said lead.
